(19) United States
(12) Patent Application Publication
(10) Pub. No.: US 2003/0051105 A1
(43) Pub. Date: Mar. 13, 2003

(54) Compact flash ATA card

(75) Inventor: Tomoya Fukuzumi, Tokyo (JP)

Correspondence Address: MCDERMOTT, WILL & EMERY, 600 13th Street, N.W., WASHINGTON, DC, 20005-3096, US

(73) Assignee: Mitsubishi Denki Kabushiki Kaisha

(21) Appl. No.: 09/987,576

(22) Filed: Nov. 15, 2001

(30) Foreign Application Priority Data
Jun. 4, 2001 (JP) 2001-168040

(51) Int. Cl. G06F 13/00

(52) U.S. Cl. 711/154

(57) ABSTRACT

A special memory space access mode enabling common memory space is added to the CF/ATA card access modes, and randomly accessible memory is allocated to the common memory space in this mode. When this special access mode is selected, data stored in the CF/ATA card is transferred to the randomly accessible memory for random access therefrom. This eliminates the need to provide a separate randomly accessible external memory to which card data is transferred for random access in order to randomly access data stored to the CF/ATA card.

### BACKGROUND OF THE INVENTION

1. Field of the Invention The present invention relates generally to a memory card, and relates more particularly to a Compact Flash card and ATA card.

2. Description of Related Art A system schematic of a Compact Flash card and a card-size ATA card, referred to below as a CF/ATA card, currently used as a data storage medium is shown in FIG. 1. Referring to FIG. 1, the host CPU 1 runs the programs. External randomly accessible memory 2 and a CF/ATA card 3 are used for storage.

The host CPU 1 can access the CF/ATA card 3 using any one of four access modes as shown in Table 1, that is, a memory map mode, contiguous I/O mode, primary 110 mode, and secondary I/O mode. The host CPU 1 automatically selects one of these four modes according to factors such as the memory configuration of the connected CF/ATA card 3. The host CPU 1 selects a particular mode by specifying the corresponding index 0h to 3h.

TABLE 1

| Index | Mode |
|---|---|
| 0 h | memory map mode |
| 1 h | contiguous I/O mode |
| 2 h | primary I/O mode |
| 3 h | secondary I/O mode |

Normal data access (that is, accessing the attribute memory space described below) to this CF/ATA card 3 is based on the data register stored to the ATA register (described below). ATA register mapping in the contiguous I/O mode shown in Table 1 is shown in Table 2.

TABLE 2

| | | | | | | | | REGISTER/MEMORY | | | |
|---|---|---|---|---|---|---|---|---|---|---|---|
| REG | CE2 | CE1 | A10-A4 | A3 | A2 | A1 | A0 | IORD = L | IOWR = L | WE = L | OE = L |
| 0 | 0 | 0 | x | 0 | 0 | 0 | x | data register | data register | attribute | attribute |
| 0 | 1 | 0 | x | 0 | 0 | 0 | 0 | data register | data register | memory | memory |
| 0 | 1 | 0 | x | 0 | 0 | 0 | 1 | error register | function selection | (attribute | (attribute |
| 0 | 0 | 1 | x | 0 | 0 | 0 | x | error register | function selection | memory | memory |
| 0 | 0 | 0 | x | 0 | 0 | 1 | x | sector count, | sector count, | space) | space) |
| | | | | | | | | sector number | sector number | | |
| 0 | 1 | 0 | x | 0 | 0 | 1 | 0 | sector count | sector count | | |
| 0 | 1 | 0 | x | 0 | 0 | 1 | 1 | sector number | sector number | | |
| 0 | 0 | 1 | x | 0 | 0 | 1 | x | sector number | sector number | | |
| 0 | 0 | 0 | x | 0 | 1 | 0 | x | cylinder high | cylinder high | | |
| | | | | | | | | cylinder low | cylinder low | | |
| 0 | 1 | 0 | x | 0 | 1 | 0 | 0 | cylinder low | cylinder low | | |
| 0 | 1 | 0 | x | 0 | 1 | 0 | 1 | cylinder high | cylinder high | | |
| 0 | 0 | 1 | x | 0 | 1 | 0 | x | cylinder high | cylinder high | | |
| 0 | 0 | 0 | x | 0 | 1 | 1 | x | drive head | drive head | | |
| | | | | | | | | status register | command register | | |
| 0 | 1 | 0 | x | 0 | 1 | 1 | 0 | drive head | drive head | | |
| 0 | 1 | 0 | x | 0 | 1 | 1 | 1 | status register | command register | | |
| 0 | 0 | 1 | x | 0 | 1 | 1 | x | status register | command register | | |
| 0 | 0 | 0 | x | 1 | 0 | 0 | x | data register | data register | | |
| 0 | 1 | 0 | x | 1 | 0 | 0 | 0 | data register | data register | | |
| 0 | 1 | 0 | x | 1 | 0 | 0 | 1 | data register | data register | | |
| 0 | 0 | 1 | x | 1 | 0 | 0 | x | data register | data register | | |
| 0 | 0 | 0 | x | 1 | 1 | 0 | x | error register | function selection | | |
| 0 | 1 | 0 | x | 1 | 1 | 0 | 1 | error register | function selection | | |
| 0 | 0 | 1 | x | 1 | 1 | 0 | x | error register | function selection | | |
| 0 | 0 | 0 | x | 1 | 1 | 1 | x | alternate status | device control | | |
| | | | | | | | | drive address | | | |
| 0 | 1 | 0 | x | 1 | 1 | 1 | 0 | alternate status | device control | | |
| 0 | 1 | 0 | x | 1 | 1 | 1 | 1 | drive address | disabled | | |
| 0 | 0 | 1 | x | 1 | 1 | 1 | x | drive address | disabled | | |
| 1 | x | x | x | x | x | x | x | disabled | disabled | disabled | disabled |

The mapping example shown in the first row of Table 2 shows mapping the data register for reading when IORD=L and IOWR=OE=WE=H, mapping the data register for writing when IOWR=L and IORD=OE=WE=H, mapping the attribute memory for reading when OE=L and IORD=IOWR=WE=H, and mapping the attribute memory for writing when WE=L and IORD=IOWR=OE=H, to REG=0, CE2=0, CE1=0, A3=0, A2=0, A1=0.

While there is attribute memory space selected when REG=0 and common memory space selected when REG=1, specifying the common memory space is disabled as shown in FIG. 2. Attribute memory is a storage area in attribute memory space.

The procedure for the host CPU 1 to access data stored to the CF/ATA card 3 is shown below.

(1) The host CPU 1 sets the sector number sent to the sector count register.

(2) The host CPU 1 sets the logical sector address for accessing the sector number register, cylinder high/low register, and drive head register.

The cylinder high/low register is used to specify the high or low cylinder when the memory space of a single card is divided into high and low cylinders. The drive head register is used to specify a particular card when plural cards are connected.

(3) The host CPU 1 sets a sector read command in the command register.

(4) The host CPU 1 waits for permission to read data from the card.

(5) When data read permission is confirmed, 512 bytes of data is serially read in byte or word units via the data register and stored to memory 2.

(6) Steps 4 and 5 are repeated for the number of sectors specified in (1), and access then ends.

It will be apparent that because the data access unit used to access a conventional CF/ATA card 3 is the sector (normally 512 bytes) and the card cannot be accessed through the ATA register, the host CPU 1 cannot randomly access data stored to the CF/ATA card 3.

This means that when a program, for example, is stored to the CF/ATA card 3, the host CPU 1 must transfer the program from the CF/ATA card 3 to external memory 2 in order to randomly access the transferred data and run the program. The same procedure is used to access a hard disk. As is known, random access is a method enabling parallel reading of data by directly specifying the address of the area where data is stored in units of 32 bits or 64 bits.

Because it is thus not possible to randomly access a CF/ATA card 3, randomly accessible external memory 2 separate from the CF/ATA card 3 must be provided when data that must be randomly accessed (such as a program) is stored to the CF/ATA card 3. The host CPU 1 can then transfer the data from the CF/ATA card 3 to the memory 2 and run the program from the external memory 2. It is therefore necessary to provide external memory sized according to the capacity of the CF/ATA card 3.

An object of the present invention is therefore to provide a CF/ATA card that can be randomly accessed by providing a special access mode enabling the common memory space and allocating randomly accessible memory in the common memory space.

### SUMMARY OF THE INVENTION

To achieve this object a special memory space access mode enabling the common memory space is added to the CF/ATA card access modes, and randomly accessible memory is allocated in the common memory space. When this special memory space access mode is selected, data stored to the CF/ATA card is transferred to the randomly accessible memory and then randomly accessed therefrom.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a system schematic of a conventional CF/ATA card;

FIG. 2 is a system schematic of a CF/ATA card according to the present invention;

FIG. 3 shows the internal configuration of the CF/ATA card shown in FIG. 2; and

FIG. 4 shows the internal configuration of the host interface shown in FIG. 3.

### DESCRIPTION OF THE PREFERRED EMBODIMENTS

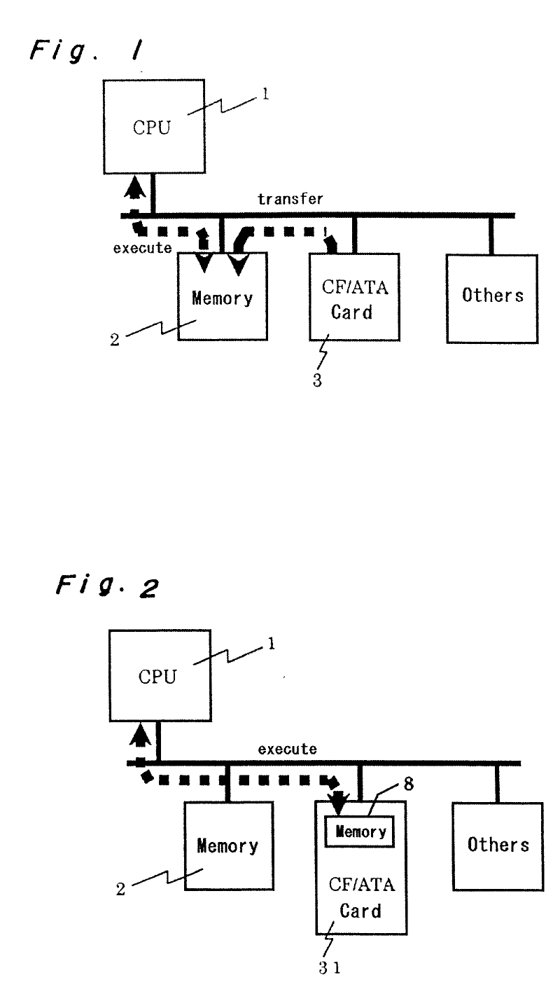

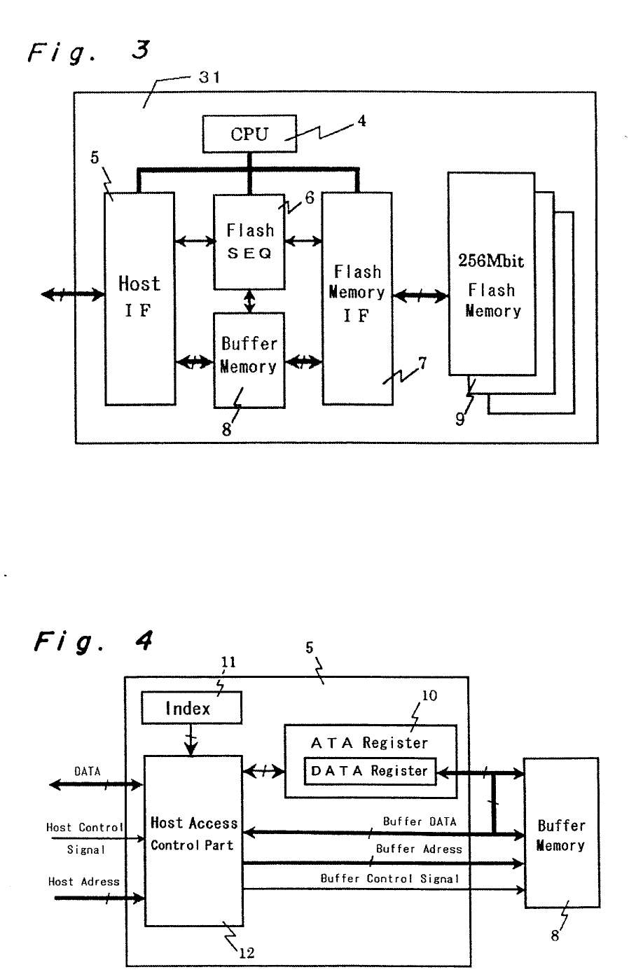

FIG. 2 is a system schematic of a CF/ATA card according to a preferred embodiment of the present invention. The buffer memory 8 provided in the CF/ATA card 31 is made randomly accessible. The internal configuration of this CF/ATA card 31 is shown in FIG. 3.

Referring to FIG. 3, a CPU 4 inside the CF/ATA card 31 controls the internal operations of the CF/ATA card 31. A host interface 5 controls communication with the host CPU 1. A flash sequencer 6 controls sequential read/write operations to the flash memory 9 further described below. A flash memory interface 7 reads and writes to the 256 Mbit flash memory 9 in response to signals from the flash sequencer 6. The flash memory 9 is internal memory for the CF/ATA card 31.

FIG. 4 shows the basic configuration of the host interface 5. The ATA register 10 contains the data register normally used to access the CF/ATA card 31. The indices noted above are stored to the index storage unit 11. The host access controller 12 controls access to the ATA register 10 and buffer memory 8 of the CF/ATA card 31 according to the index value from the index storage unit 11 and the host address and host control signal from the host CPU 1.

The host CPU 1 selects from the four access modes shown in Table 1, that is, a memory map mode, contiguous I/O mode, primary I/O mode, and secondary I/O mode, to access a conventional CF/ATA card 3. The present invention complements these by adding a “special memory space access mode” selected by specifying index 4h. The host CPU 1 can thus select from the five access modes shown in Table 3 to access a CF/ATA card 31 according to the present invention.

TABLE 3

| Index | Mode |
|---|---|
| 0 h | memory map mode |
| 1 h | contiguous I/O mode |
| 2 h | primary I/O mode |
| 3 h | secondary I/O mode |
| 4 h | special memory space access |
| | mode |

An example of mapping the ATA register 10 and special memory space in this special memory space access mode is shown in Table 4.

TABLE 4

| | | | | | | | | REGISTER/MEMORY | | | |
|---|---|---|---|---|---|---|---|---|---|---|---|
| REG | CE2 | CE1 | A10-A4 | A3 | A2 | A1 | A0 | IORD = L | IOWR = L | OE = L | WE = L |
| 0 | 0 | 0 | x | 0 | 0 | 0 | x | data register | data register | attribute | attribute |
| 0 | 1 | 0 | x | 0 | 0 | 0 | 0 | data register | data register | memory | memory |
| 0 | 1 | 0 | x | 0 | 0 | 0 | 1 | error register | function | (attribute | (attribute |
| | | | | | | | | | selection | memory | memory |
| 0 | 0 | 1 | X | 0 | 0 | 0 | x | error register | function | space) | space) |
| | | | | | | | | | selection | | |
| 0 | 0 | 0 | x | 0 | 0 | 1 | x | sector count, | sector count, | | |
| | | | | | | | | sector number | sector number | | |
| 0 | 1 | 0 | x | 0 | 0 | 1 | 0 | sector count | sector count | | |
| 0 | 1 | 0 | x | 0 | 0 | 1 | 1 | sector number | sector number | | |
| 0 | 0 | 1 | x | 0 | 0 | 1 | x | sector number | sector number | | |
| 0 | 0 | 0 | x | 0 | 1 | 0 | x | cylinder high | cylinder high | | |
| | | | | | | | | cylinder low | cylinder low | | |
| 0 | 1 | 0 | x | 0 | 1 | 0 | 0 | cylinder low | cylinder low | | |
| 0 | 1 | 0 | x | 0 | 1 | 0 | 1 | cylinder high | cylinder high | | |
| 0 | 0 | 1 | x | 0 | 1 | 0 | x | cylinder high | cylinder high | | |
| 0 | 0 | 0 | x | 0 | 1 | 1 | x | drive head | drive head | | |
| | | | | | | | | status register | command | | |
| | | | | | | | | | register | | |
| 0 | 1 | 0 | x | 0 | 1 | 1 | 0 | drive head | drive head | | |
| 0 | 1 | 0 | x | 0 | 1 | 1 | 1 | status register | command | | |
| | | | | | | | | | register | | |
| 0 | 0 | 1 | x | 0 | 1 | 1 | x | status register | command | | |
| | | | | | | | | | register | | |
| 0 | 0 | 0 | x | 1 | 0 | 0 | x | data register | data register | | |
| 0 | 1 | 0 | x | 1 | 0 | 0 | 0 | data register | data register | | |
| 0 | 1 | 0 | x | 1 | 0 | 0 | 1 | data register | data register | | |
| 0 | 0 | 1 | x | 1 | 0 | 0 | x | data register | data register | | |
| 0 | 0 | 0 | x | 1 | 1 | 0 | x | error register | function | | |
| | | | | | | | | | selection | | |
| 0 | 1 | 0 | x | 1 | 1 | 0 | 1 | error register | function | | |
| | | | | | | | | | selection | | |
| 0 | 0 | 1 | x | 1 | 1 | 0 | x | error register | function | | |
| | | | | | | | | | selection | | |
| 0 | 0 | 0 | x | 1 | 1 | 1 | x | alternate | device control | | |
| | | | | | | | | status drive | | | |
| | | | | | | | | address | | | |
| 0 | 1 | 0 | x | 1 | 1 | 1 | 0 | alternate | device control | | |
| | | | | | | | | status | | | |
| 0 | 1 | 0 | x | 1 | 1 | 1 | 1 | drive address | disabled | | |
| 0 | 0 | 1 | x | 1 | 1 | 1 | x | drive address | disabled | | |

| | | | | | | | |
|---|---|---|---|---|---|---|---|
| 1 | 0 | 0 | arbitrary | disabled | disabled | buffer | buffer |
| 1 | 1 | 0 | arbitrary | | | memory | memory |
| 1 | 0 | 1 | arbitrary | | | (common | (common |
| | | | | | | memory | memory |
| | | | | | | space) | space) |

The attribute memory space and common memory space are also present in this special memory space access mode, but specifying the common memory space is enabled in this access mode, and the above-noted buffer memory 8 is allocated to this enabled common memory space.

This buffer memory is also provided in conventional memory cards, but in a conventional memory card the buffer memory is not directly accessible to the host CPU 1 and can only be accessed through the ATA register. The buffer memory 8 allocated to the common memory space in a CF/ATA card according to the present invention, however, can be directly accessed, that is, randomly accessed, by the host CPU 1 using a procedure described more fully below.

To access the ATA register 10 in the host interface 5, the host CPU 1 writes the sector number and command in steps (1) to (3) below as in the prior art method described above.

1 (1) The host CPU 1 sets the sector number sent to the sector count register.

(2) The host CPU 1 sets the logical sector address for accessing the sector number register, cylinder high/low register, and drive head register.

(3) The host CPU 1 sets a sector read command in the command register.

(4′) When the CPU 4 in the CF/ATA card 31 receives the information from steps (1) to (3), it sends a command to the flash sequencer 6 to transfer data from the flash memory 9 into the buffer memory 8, and then sends a request to read the data in the flash memory 9 to the host CPU 1.

(5′) When the host CPU 1 confirms the data read request, it accesses the data through one of the data registers in the ATA register 10. The host access controller 12 in FIG. 4 then controls buffer memory 8 access and data, and outputs the data to the host CPU 1. The host CPU 1 stores the read data to the buffer memory 8. Because the host CPU 1 can directly access the common memory space, it can also randomly access data in the buffer memory 8 allocated in the common memory space.

This method thus does not require a large capacity external memory 2 to save the data, and can therefore be advantageously used in systems that cannot have a large capacity external memory. In addition, the capacity of the buffer memory 8 of the CF/ATA card 31 can be set to the smallest capacity needed according to the capacity of the flash memory 9, and unnecessary memory can be eliminated.

It should be noted that when the contiguous I/O mode, for example, is selected, data stored to the CF/ATA card 31 can be accessed using the same steps (1) to (6) described in the prior art above.

It will also be noted that special memory space addresses in this embodiment are based on the contiguous I/O mode as will be known by comparing Table 2 and Table 4, but can alternatively be based on another access mode that uses common memory space, including the primary I/O mode or secondary I/O mode.

As will be known from the preceding description, the present invention adds another CF/ATA card access mode, that is, a special memory space access mode enabling common memory space to be specified, and allocates randomly accessible memory to that common memory space, thereby enabling data transferred from the card to that memory to be randomly accessed.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom

What is claimed is:

1. A CF/ATA card characterized by adding a new access mode enabling common memory space to the memory card access modes.

2. A CF/ATA card characterized by adding a new access mode enabling common memory space to a memory card access mode, the memory card access mode being a contiguous I/O mode, primary I/O mode, or secondary I/O mode.

3. A CF/ATA card as described in claim 2, wherein randomly accessible memory is allocated to the common memory space.

4. A CF/ATA card as described in claim 3, wherein the randomly accessible memory has a capacity determined by the card storage capacity.

5. A CF/ATA card as described in claim 3, comprising a transfer function for transferring data stored in the card to the randomly accessible memory, and randomly accessing data in said memory.

6. A CF/ATA card as described in claim 4, comprising a transfer function for transferring data stored in the card to the randomly accessible memory, and randomly accessing data in said memory.

7. A CF/ATA card characterized by:
adding a new access mode enabling common memory space to a memory card access mode, the memory card access mode being a contiguous I/O mode, primary I/O mode, or secondary I/O mode;
allocating randomly accessible memory to the common memory space; and
randomly accessing data in said memory when the new access mode is selected after first transferring data stored in the card to the randomly accessible memory.
